(19) United States
(12) Patent Application Publication
(10) Pub. No.: US 2023/0321681 A1
(43) Pub. Date: Oct. 12, 2023

(54) Material Spreader with Selective Liquid Treatment By-Pass

(71) Applicant: Premier Design Innovations LLC, Dawson, NE (US)

(72) Inventors: Rodney R. Heinen, Dawson, NE (US); Garrett A. Witthar, Valley Center, KS (US); Karin N. Witthar, Valley Center, KS (US)

(73) Assignee: Premier Design Innovations LLC, Dawson, NE (US)

(21) Appl. No.: 17/658,107

(22) Filed: Apr. 6, 2022

(51) Int. Cl. B05B 13/02; A01C 17/00; A01C 15/00; A01C 15/18

(52) U.S. Cl. CPC B05B 13/025; A01C 17/001; A01C 15/006; A01C 15/18

(57) ABSTRACT

A material spreader that permits selective liquid treatment of particulate material from the same spreader bed. The spreader bed is comprised of a hopper, a plurality of chain belts, a liquid treatment system, and a mixing and drying assembly which delivers the treated particulate material to the spreaders. The chain belts can drive in a forward direction for liquid treating or an aft direction for no liquid treating. Selective bypass permits non-treated particulate material to be spread without contamination from the liquid treatment.

### FIELD OF THE INVENTION

The present disclosure relates to spreader beds with a liquid treatment system for use in spreading fertilizer, agricultural lime, and other dry products.

### BACKGROUND

Spreading fertilizer with a material spreader incorporating liquid treatment has the benefit of applying fertilizer with a variety of liquid coating materials during spreading operations. The liquid coating material applied may be a chemical treatment, such as herbicide, stabilizer, or a combination of both, that increases the performance of the fertilizer treated. However, there are situations where the liquid coating material selected may vary, depending on the fertilizer used, or is not required as application of the treatment may be detrimental to the specific field where the fertilizer is applied. Dry fertilizer application practices have been developed to apply liquid coating materials to dry fertilizer in a way that the dry fertilizer does not become problematic to work with after treatment. Some practices impregnate dry fertilizer with weed and brush chemicals like GRAZON® (Dow AgroSciences Limited) to apply the chemical prior to the dry fertilizer being spread to the immediate area of distribution. However, this chemical can remain as a residue on surfaces contacted by the impregnated fertilizer such as a blender, tender truck, and the material spreader components. In some cases, the residue on the equipment components must be thoroughly cleaned and is often impossible to entirely remove. Other practices apply a liquid treatment to a particulate material, on demand, if the liquid treatment is not required in all situations. For example, urea may be applied to a farm field immediately before rain and benefit the soil untreated. If untreated, urea spread without precipitation will volatilize and add no benefit to the soil. A way to spread the urea when precipitation is not forecasted is to treat the urea with an expensive stabilizer. On demand treating allows the particulate material to be treated as needed. However, particulate material treated by current on demand liquid material spreaders do not address untreated particulate material coming into contact with components contaminated with residual treatment.

### SUMMARY

The material spreader is capable to treat dry products such as fertilizer, sand, seed, and other particulate material with liquid treatment by an on-demand liquid treatment system. Alternatively, the material spreader is capable to by-pass the liquid treatment system with little to no risk of treatment residue encountering the particulate material spread. The material spreader is operable to scatter particulate material, with or without a liquid treatment applied to the particulate material. Operating the material spreader in a liquid treatment application mode may occur at selected distribution sites or toggled on/off for specific areas within a single distribution site. A first conveyor system, being an endless, reversible conveyor, comprises chain belts that are operable to move the particulate material received from a hopper of the material spreader. The hopper comprises two doors with the first conveyor system serving as the floor of the hopper. The first conveyor system may move particulate material received from the hopper in a first, forward direction to transport particulate material to a first treatment zone prior to spreading. A treatment chamber in the first treatment zone is configured in such a manner to separate the first conveyor system from a second conveyor system. Alternatively, the first conveyor system may move particulate material received from the hopper in a second, aft direction to bypass the first treatment zone and move particulate material directly to a spreading assembly. Bypass of the first treatment zone permits non-treated particulate material to be spread without being treated by the liquid treatment system. The second conveyor system may comprise auger flights that convey the treated particulate material received from the first treatment zone to an outlet delivery system which may comprise the same spreading assembly. The second conveyor system moves the treated particulate material in a parallel counter flow relative to the movement of the pre-treated particulate material on the reversible conveyor. Use of the spreader bed provides a method for preventing residual liquid treatment waste from contaminating the first conveyor of the spreader system.

For applications of dry product not treated with the liquid, the dry product is placed into the hopper of the spreader bed where it is held. As the spreader moves through the field, two separate chain belts on the bottom of the hopper moves the dry product towards the back of the spreader bed and out of a gate. The chain belts may both run or one may be stationary for distribution control. The dry product falls on two spinners that are spinning in two different directions, thus throwing the dry product out of the spreader. The spinners have multiple blades to aid in spreading the dry product in the distribution pattern selected. The spinners may rotate in opposite directions from each other and rotate away from the center of the spreader bed. The right spinner is spreading dry product towards the right side of the spreader bed and the left spinner is spreading dry product towards the left side of the spreader bed.

For applications of dry product treated with the liquid, the dry product is placed into the hopper of the spreader bed. As the spreader moves through the field, two separate chain belts on the bottom of the hopper moves the dry product towards the front of the spreader bed and out a gate. The chain belts may both run or one may be stationary for distribution control. The dry product is pushed through the chain belt by a pressure mat to break up any oversized chunks of dry product. The dry product falls upon a diverter plate to direct the dry product towards a respective mixing passage. When the dry product is falling off the diverter plate, it is sprayed with the liquid via spray nozzles, atomizing devices, or other liquid distribution assemblies. The liquid may be atomized into a fog or mist by the liquid distribution assemblies. The liquid distribution assemblies may be a component of an on-demand liquid treatment system. Treating with an on-demand liquid treatment system allows liquid treatment to be applied constantly or at intervals of time to the particulate material so that the selected, uniform blend is occurring. This may be advantageous over batch treatment, as batch treating may not be able to ensure consistency throughout the full batch treatment process. Once in a passage of the mixing and drying system, the treated product is mixed and dried while moved to the back of the spreader bed towards the outlet deliver system.

To increase the mixing and drying of treated product, helical flighted bodies may be used. These helical flighted bodies may be shaftless in the sense they do not have a continuous large center shaft that can hinder effective mixing. The helical flighted bodies may contain three stiffener rods disposed along an outside perimeter of a center shaft in phantom. The three stiffeners provide structural support to the helical flighting. The stiffener rods provide two mixing aspects: 1) encouragement for a portion of the treated product to fall back onto itself; 2) allowance for treated product to fall forward into an inner zone of the helical flighted body. Kickers or other mixing enhancements may be disposed on the helical flighting and/or the stiffener rods. These aspects and features engage and increase turnover of the treated product. Once the treated product has been conveyed to the aft portion of the spreader bed it falls to the spinners for distribution. Advantageously, the only equipment which may be contaminated by the chemical or treatment is the spinners, mixing passages, and the treatment chamber. A cover may be utilized to enclose the spinners while spreading treated product.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 is a front perspective view of the material spreader constructed in accordance with a first example;

FIG. 2 is a side elevational view of the material spreader depicted in FIG. 1;

FIG. 3 is a top elevation view of the material spreader depicted in FIG. 1;

FIG. 4 is a cross-sectional view of the material spreader taken along Line 4-4 in FIG. 3, showing the treatment path through the process;

FIG. 5 is a front perspective view of the material spreader in FIG. 1, with fragmentary portions of the material spreader removed to illustrate structure located behind the drive train;

FIG. 6 is a rear perspective view of the material spreader in FIG. 1; and

FIG. 7 is a side perspective view of a helical flighted body with stiffener rods.

### DETAILED DESCRIPTION

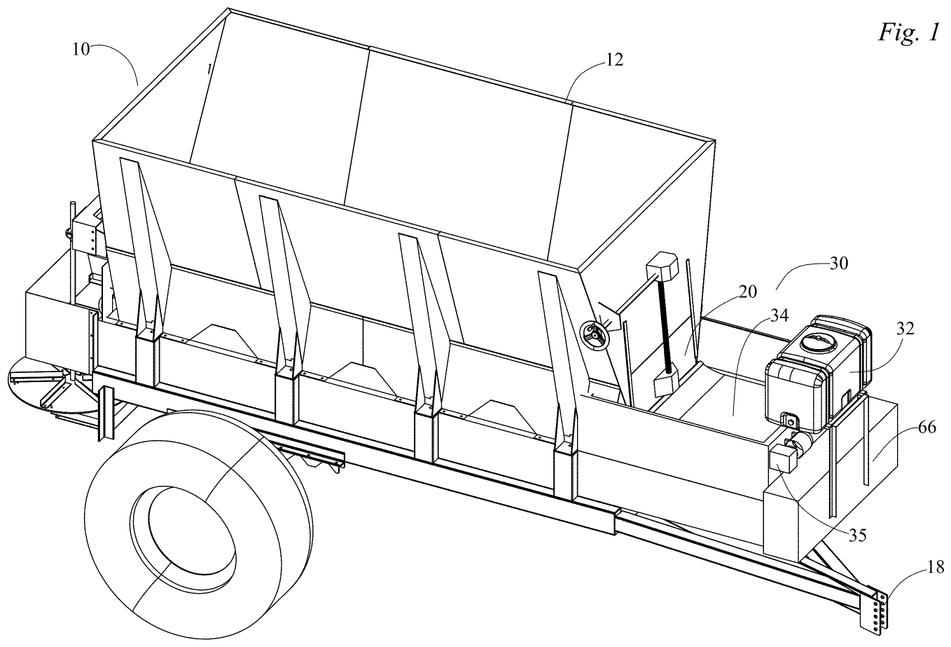

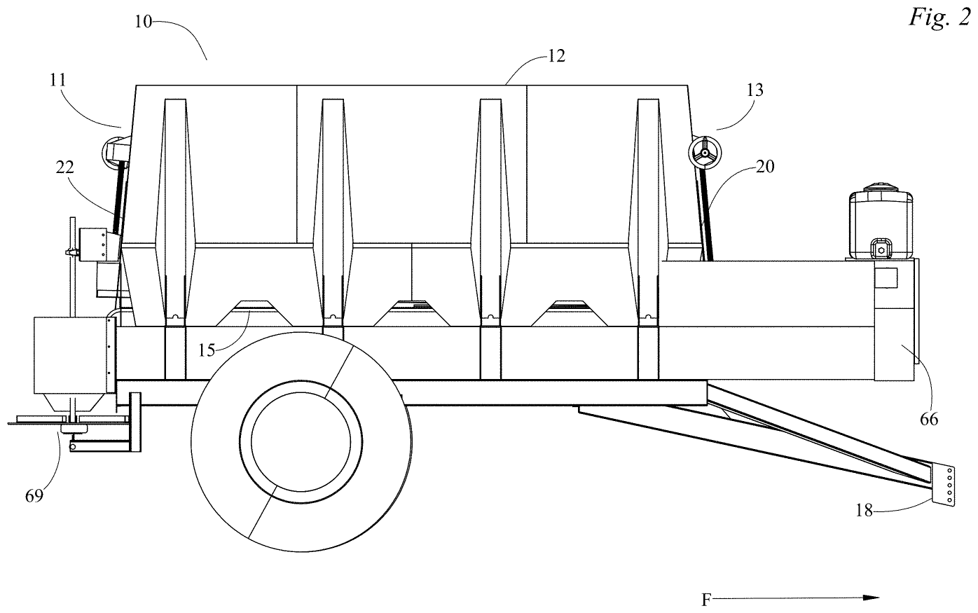

Referring initially to FIGS. 1-7, a portable material spreader comprises a spreader bed 10 that includes a hopper 12, a first conveyor system 15 being an endless, reversible conveyor comprising a plurality of chain belts, a liquid treatment system 30, and a second conveyor system 50 comprising a plurality of flighted bodies disposed within a mixing and drying assembly. The spreader bed 10 is designed to treat particulate material with a liquid coating material and spread the treated particulate material 25 out the aft of the material spreader. As shown in FIG. 2, the spreader bed 10 is configured to be pulled in a forward direction (according to movement arrow F). A tongue 18 is attached on the forward end of the spreader bed 10 to connect the material spreader to a towing vehicle (not shown).

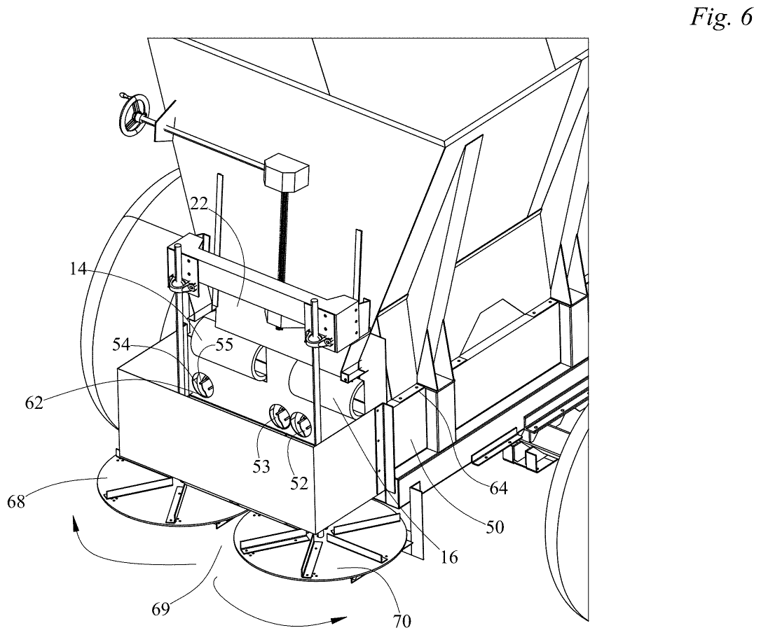

As shown in FIGS. 1 and 6, the hopper 12 of the spreader bed 10 includes two gates, a first or forward gate 20 and a second or aft gate 22, which may be jointly or independently operated. The forward gate 20 and aft gate 22 are configured to open proportionately to an output speed of the first conveyor system 15 and a second conveyor system 50. The first conveyor system 15 may be directed in a rearward direction. Aft gate 22 may be located at a dispensing end 11 of the spreader bed 10. Aft gate 22 opens to control the flow of non-treated particulate material for distribution to spreader elements of a spreader assembly 69. The spreader assembly 69 depicted comprises two spinners as the spreader elements, a left spinner 68 and a right spinner 70 (see FIGS. 2 and 6). The first conveyor system 15 may be directed in a forward direction. Forward gate 20 may be located at a second end 13 of the spreader bed 10. Forward gate 20 opens to control the flow of particulate material for the treating process (see FIGS. 1, 4, and 5). This path of the particulate material is indicated with movement arrow-headed lines 100.

The plurality of chain belts may comprise a first chain belt 14 and a second chain belt 16 that are jointly or independently controlled to operate either towards the dispensing end 11 or the second end 13 of the spreader bed 10 (see FIGS. 1-6). A drive mechanism may be operably connected between the first chain belt 14, the second chain belt 16, and a motive source to drive the chain belts. When the chain belt 14, 16 is moving forward, forward gate 20 will open for transport of the particulate material to a treatment chamber for treatment of the particulate material by a liquid treatment system 30. The first chain belt 14 is operable to move if the second chain belt 16 is stationary and vice versa. Chain belt 14, 16 carry the particulate material to the liquid treatment system 30. The particulate material falls through the chain belt 14, 16 directly onto a diverter plate 36, 38 and into the mixing and drying passages of the mixing and drying assembly. Therefore, chain belts 14, 16 are kept clean from any sprayed treatment by treating particulate material after dispensing from the hopper 12. The liquid distribution assemblies 40, 42, 44, 46 spray the liquid treatment onto the particulate material before it rotates within the mixing and drying assembly by the flighted bodies. The mixing and drying assembly conveys the treated particulate material to the spreader assembly 69 for distribution onto the field. Spreaders may be changed or cleaned between each application mode.

During the process of spreading untreated or unimpregnated fertilizer, the chain belt 14, 16 may move backwards, feeding the fertilizer to the aft or dispensing end 11 of the material spreader, and drop the fertilizer onto the spinners 68, 70 of the spreader assembly 69. This path of the particulate material is indicated with movement circle-headed lines 200. With the material spreader disclosed, an operator may also treat or impregnate the fertilizer. In one example, an operator may operate hydraulic valves to reverse the direction of hydraulic oil flow driving the chain belt 14, 16, thus causing the chain belt 14, 16 to move forward (movement arrow F) rather than backwards. The forward gate 20 on the front of the spreader bed 10 may be substantially like the aft gate 22 on the back of the spreader bed 10. Thus, when the fertilizer is being treated chemically, fertilizer moves forward and falls into the treatment chamber where it is treated and agitated in the mixing and drying assembly as it goes backwards to the spinners 68, 70. Advantageously, the only equipment which may be contaminated by the chemical or liquid treatment 31 is the spinners 68, 70, the treatment chamber, and the mixing and drying assembly. If the operator resumes spreading untreated fertilizer, the operator may simply cleanse the spinners 68, 70. Therefore, the fertilizer is not touched by the residue left in the treatment chamber or the mixing and drying assembly.

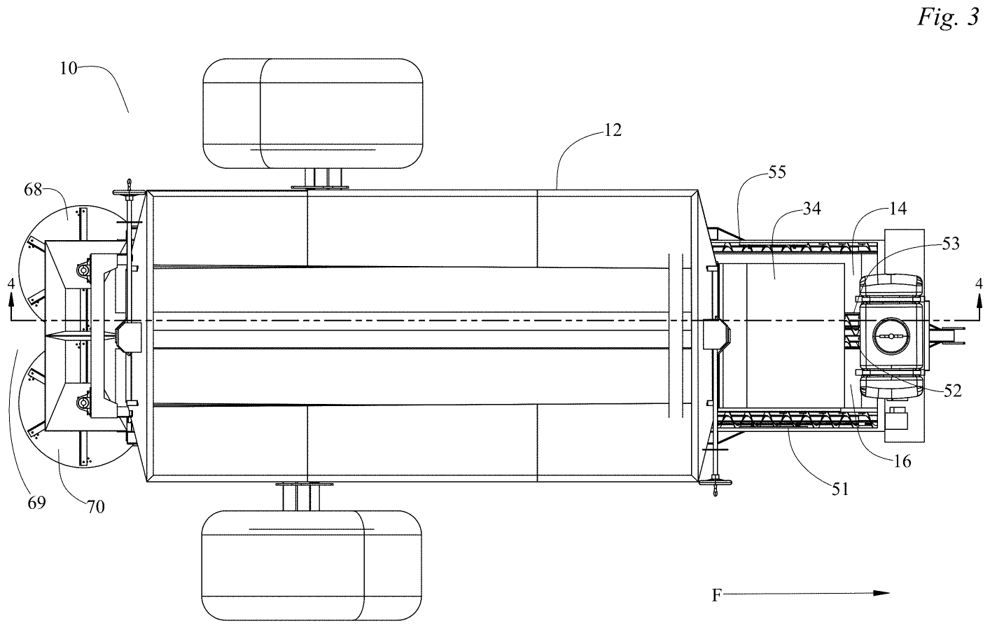

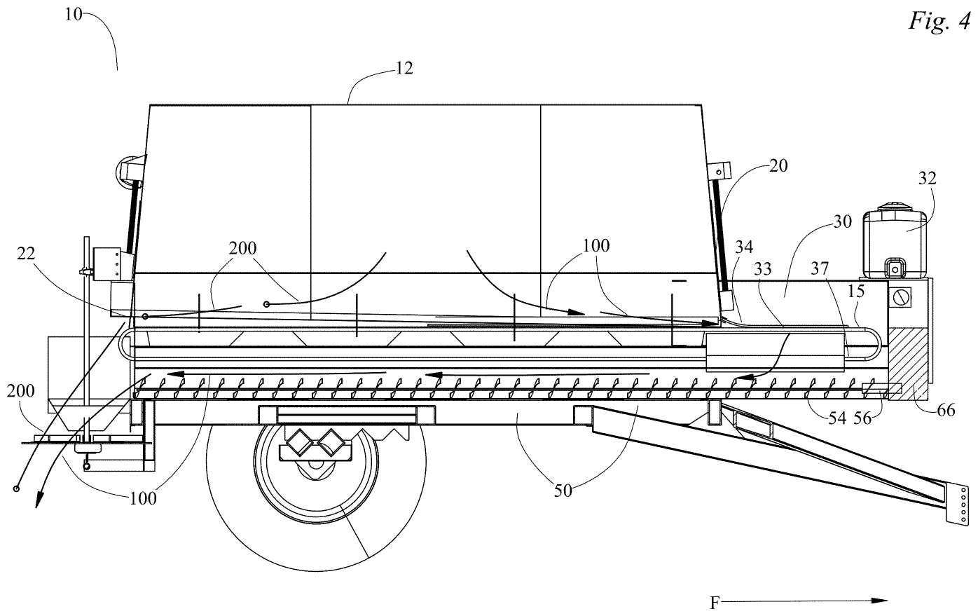

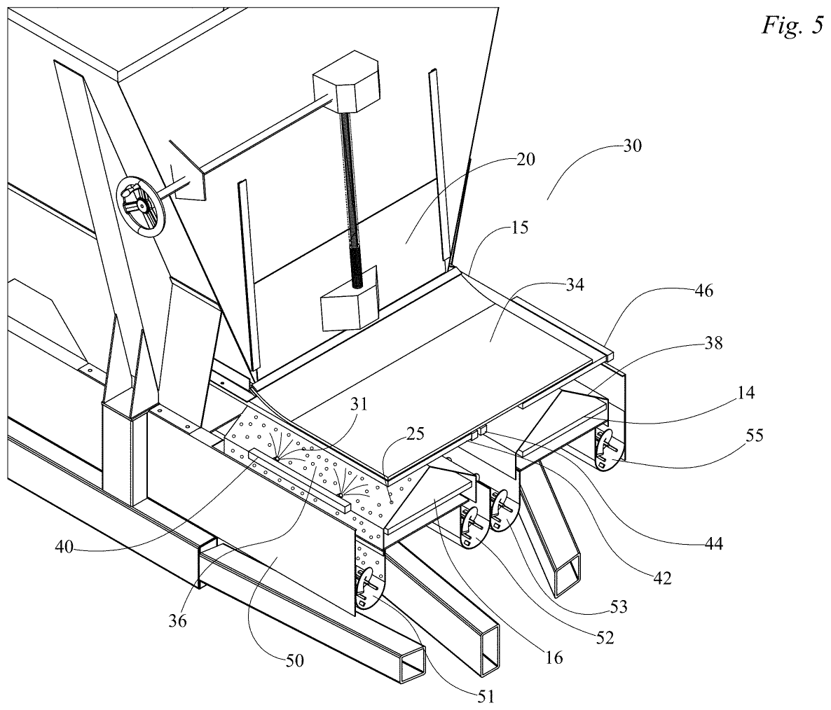

As shown in FIG. 4 and FIG. 5, the liquid treatment system 30 contains a liquid tank 32, pressure mat 34, a first diverter plate 36, and a second diverter plate 38, and liquid distribution assemblies 40, 42, 44, 46 (see FIGS. 3, 4, and 5). As the chain belt 14, 16 moves forward, the forward gate 20 opens to allow particulate material to pass under the pressure mat 34 in a material contact portion 33. Since some particulate materials conglomerate when compactly stored, the pressure mat 34 will break up and dissipate larger chunks in the material contact portion 33. Alternatively, a plurality of silicone or rubber rollers may be utilized in place of the pressure mat. The pressure mat 34 material may be rubber, alternatively silicone, nitrile, vinyl, neoprene or like material that may be used with durometers between Shore A 20-90. The thickness of the pressure mat 34 is between 0.125 to 0.50 inch thick. The pressure mat 34 may be up to two inches in thickness or thicker, depending on the material selected and the friableness of the particulate material. Particulate material smaller than the plurality of openings in the chain belt 14, 16 can fall through the chain belt 14, 16 to the diverter plate 36, 38.

The liquid treatment system 30 may include an air-assisted mist blower positioned adjacently below where the fertilizer travels through the chain belts and falls away onto the augers. The mist blower atomizes the chemical or liquid treatment from a liquid flow into a fog or mist. A return portion 37 of the first conveyor system 15, which is disposed below the material contact portion 33 of the first conveyor system 15, is protected from liquid treatment 31 by a diverter plate 36, 38. The diverter plate 36, 38 overlaps the return portion 37. As shown, the diverter plate 36, 38 is an inverted V-shape, but may also be U-shaped. Particulate material falling onto the diverter plate 36, 38 is directed towards a plurality of passages of the mixing and drying assembly. As the particulate material travels through and falls away from the chain belt 14, 16 towards the diverter plate 36, 38, the four liquid distribution assemblies 40, 42, 44, 46 shown apply the liquid treatment 31 sourced from the liquid tank 32. The four liquid distribution assemblies 40, 42, 44, 46 are a plurality of atomizing sprayers configured to spray a liquid coating material onto the falling particulate material. The liquid coating material may be sprayed perpendicular to the flow of the particulate material dispensed. Alternatively, the liquid coating material may be sprayed downwardly onto the particulate material agitated within the mixing and drying assembly. The dry fertilizer is contacted with the liquid treatment as a mist and then transferred the length of the spreader bed via the second conveyor system 50.

As depicted in FIG. 5 and FIG. 6, the mixing and drying assembly has four identical passages 51, 52, 53, 55. Each passage of the mixing and drying assembly includes a trough 62 for enclosing the treated particulate material 25. The second conveyor system 50 transports the treated particulate material 25 along the trough 62 of each passage 51, 52, 53, 55. In one example, the second conveyor system 50 may comprise four augers that agitate and mix the treated fertilizer. An auger may be about six inches in diameter and be disposed inside an approximately 6.25-inch U-shaped trough or tubular passage. The tubular passages may be lined with plastic such as ultra-high molecular weight polyethylene (UHMW), tubular metal sheeting, or other durable material. The augers may extend and run longitudinally the length of the spreader bed 10 to deliver treated fertilizer from front to back. The augers positioned underneath the spreader bed 10 allow residence time before dropping the treated product onto the spinners 68, 70. On the aft end of the spreader bed 10, two passages 53, 55 are disposed over the left spinner 68 and two passages 51, 52 are disposed over the right spinner 70. As seen from above in FIG. 6, left spinner 68 is rotating clockwise and right spinner 70 is rotating counterclockwise. Particulate material falling onto the spinners 68, 70 that are spinning, may be thrown in an arcuate pattern generally 50 feet to 100 feet away from the aft end of the spreader bed 10 at the distribution site.

The second conveyor system 50 is operably connected to the drive train 66 located on the forward end of the spreader bed 10 as shown in FIG. 1. The drive train 66 may power both the chain belts 14, 16 and the flighted bodies of the mixing and drying assembly. In action, the particulate material will enter each passage as it falls from the chain belts 14, 16 and the diverter plates 36, 38 in the treatment chamber. A helical auger flight, hereinafter referred to as a flighted body 54, is disposed within each passage and will move the material settled within the trough 62 of the passage. Screw type conveyor movement by the flighted body 54 will mix and dry the liquid coating material on the surface of the treated particulate material 25. A dryer assembly may be installed and connected to the mixing and drying assembly to hasten the drying of the treated fertilizer if desired. A cover 64 contains the treated particulate material 25 during mixing and transport along the length of the spreader bed 10 by the flighted body 54. The cover 64 also helps contain the treated particulate material 25 to ensure no other portions of the spreader bed 10 are contaminated.

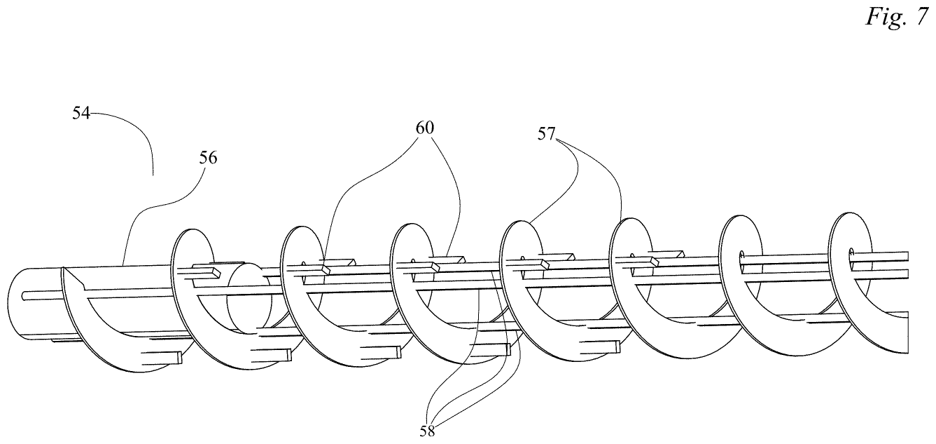

An example of a flighted body 54 is shown in FIG. 7. The flighted body 54 contains a mounting shaft 56, helical flighting 57, a plurality of mixing enhancements 60, and a plurality of stiffener rods 58. Further mixing enhancement may occur with a flighted body 54 having helical flights with an open center. Centerless helical flights provide little to no compressive mixing for newly treated particulate material 25 for the prevention of compaction and clumping. Each flighted body 54 comprises a single helical lip or thread, hereinafter referred to as helical flighting 57. Helical flighting 57 around the mounting shaft 56 of the flighted body 54 involves a helically shaped flighting structure that is uniform and extends along a longitudinal length of the flighted body 54. Alternatively, the flighting may not be continuous or uniform. For example, flighted screw augers may include a multiple start thread configuration having two or more helical lips or threads. The helical flighting 57 of a flighted body 54 disposed in each passage 51, 52, 53, 55 of the mixing and drying assembly may be orientated in the same, spinning direction. As seen from the forward end of the spreader bed 10 in FIG. 5, a plurality of flighted bodies comprise right-handed helical flighting. Treated particulate material 25 is conveyed towards the aft end of the spreader bed 10 when the plurality of flighted bodies are rotating in a counter-clockwise direction. The helical flighting 57 material may be UMHW, stainless steel, or carbon steel. The thickness of the helical flighting 57 may be between 0.125 to 0.4375 inch thick, more or less.

As seen in FIG. 7, the mounting shaft 56 of the flighted body 54 may extend into the helical flighting 57 one or more rotations of the helical flighting 57. The mounting shaft 56 may be operably connected to the drive train 66 of the portable spreader. The mounting shaft 56 material may be stainless steel. Alternatively, carbon steel may be utilized as the material for the mounting shaft 56. The mixing enhancements 60 material may be UMHW, stainless steel, or carbon steel. The thickness of the mixing enhancements 60 may be between 0.0625 to 0.4375-inch thick with a length between 20% and 100% of the helical pitch that can vary along the length of the flighted body 54. The mixing enhancements 60 can be secured by welding, friction stir welded, bonded, or cold fitted. Alternatively, the mixing enhancements 60 can be removeable and attached by bolts. The shape of the mixing enhancements 60 can vary from wedge to rectangular to conical. The three or more stiffener rods 58 provide for a flight body 54 that is shaftless on center. Material for the stiffener rods 58 may be stainless steel. Alternatively, carbon steel may be utilized as the material for the stiffener rods 58. The diameter of a stiffener rod 58 may be between 0.125 to 0.750 inches. The stiffener rods 58 may extend past the helical flighting 57 on both ends. The stiffener rods 58 can be secured by welding, friction stir welded, bonded, or cold fitted. Alternatively, the stiffener rods 58 can be removeable and attached by fasteners such as screw-threaded nuts.

Controllers can be used to carry out the processes of spreader bed 10 operations. A drive controller may direct the movement of the chain belts in forward or reverse, along with augers to turn on and operate proportionally (i.e., variable speed proportionate to the belt speed or output of particulate material from the bed) and volumetrically. The application rate of the dry product is determined by belt speed and the size of the gate openings, which may also be operated by the drive controller. For instance, if the spreader operator drives faster, the controller may increase the belt speed and the gate openings to spread more particulate material per minute. A liquid controller 35 may be comprise an application mode that engages the liquid treatment system 30 to operate. The liquid treatment system 30 may be controlled by the liquid controller 35 to selectively apply liquid treatment 31 to the particulate material. Liquid flow rates may be measured by revolutions of a positive displacement peristaltic pump since flow rates may be low.

Some spreader beds may have a bed diameter that decreases and creates a funneling effect, which causes bridging of products like lime and litter. In a preferred example, the spreader bed's diameter does not decrease but remains substantially constant from front to back. In another example, the diameter of the bed is greater near the back of the bed as compared to the diameter near the front of the bed. In a preferred example, the spreader bed is configured to treat granular fertilizer. In another example, the spreader bed may be used to treat particulate matter that includes synthetic resin, sand, salt, wood, other types of particulate material, or a combination thereof.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A portable material spreader comprising:
a) a hopper;
b) a spreader assembly disposed at a dispensing end of the portable material spreader;
c) a reversible conveyor constituting the floor of the hopper;
d) a liquid treatment system disposed at a second end of the portable material spreader, where the second end is distal to the dispensing end; and
e) a second conveyor to move a treated particulate material to the dispensing end of the portable material spreader.

2. The portable material spreader of claim 1, further comprising:
a) a first gate at the dispensing end of the portable material spreader, wherein a particulate material that passes through the first gate would fall under the force of gravity upon the spreader assembly; and
b) a second gate at the second end of the hopper, wherein the particulate material that passes through the second gate would fall under the force of gravity through the liquid treatment system.

3. The portable material spreader of claim 1, wherein the reversible conveyor comprises:
a) a first chain belt;
b) a second chain belt; and
c) wherein the first chain belt and the second chain belt are independently driven in forward and aft directions.

4. The portable material spreader of claim 1, wherein the liquid treatment system comprises:
a) a plurality of atomizing sprayers configured to spray a liquid coating material perpendicular to the flow of particulate material dispensed.

5. The portable material spreader of claim 1, wherein the second conveyor further comprises:
a) a first helical auger flight having an open center;
b) a plurality of stiffener rods extending longitudinally through the open center of the first helical auger flight; and
c) a plurality of mixing enhancements individually mounted along the first helical auger flight.

6. The portable material spreader of claim 5, wherein the second conveyor delivers the treated particulate material to the spreader assembly.

7. The portable material spreader of claim 1, wherein the treated particulate material moves with the second conveyor in a parallel counter flow relative to the movement of a pre-treated particulate material on the reversible conveyor.

8. The portable material spreader of claim 1, further comprising:
a) a liquid controller, wherein the liquid controller controls the liquid treatment system to selectively apply liquid treatment to a particulate material during an application mode.

9. The portable material spreader of claim 1, further comprising:
a) a material contact portion disposed upon the reversible conveyor.

10. The portable material spreader of claim 1, further comprising:
a) a material contact portion;
b) a return portion disposed below the material contact portion; and
c) a first diverter plate disposed between the material contact portion and the return portion.

11. A portable material spreader comprising:
a) a hopper;
b) a spreader assembly disposed at a dispensing end of the portable material spreader;
c) an endless conveyor constituting the floor of the hopper, wherein the endless conveyor comprises:
i. a material contact portion;
ii. a return portion disposed below the material contact portion; and
d) a diverter plate disposed between the material contact portion and the return portion.

12. The portable material spreader of claim 11, further comprising:
a) a liquid treatment system disposed between the material contact portion of the endless conveyor and the return portion of the endless conveyor.

13. The portable material spread of claim 12, wherein the liquid treatment system is configured to apply a liquid treatment to a particulate material that travels through the material contact portion of the endless conveyor to form a treated particulate material.

14. The portable material spreader of claim 12, wherein a particulate material that travels through the material contact portion of the endless conveyor is directed by the diverter plate to prevent a liquid treatment from contacting the return portion of the endless conveyor.

15. The portable material spreader of claim 11, wherein the diverter plate has an inverted V-shaped cross section.

16. The portable material spreader of claim 11, further comprising:
a) a pressure mat disposed upon the material contact portion to encourage a particulate material to travel through the endless conveyor.

17. The portable material spreader of claim 16, wherein the endless conveyor is a chain belt.
